(19) United States
(12) Patent Application Publication
(10) Pub. No.: US 2008/0047300 A1
(43) Pub. Date: Feb. 28, 2008

(54) Defect reduction in manufacture glass sheets by fusion process

(76) Inventor: Randy L. Rhoads, Horseheads, NY (US)

Correspondence Address: CORNING INCORPORATED, SP-TI-3-1, CORNING, NY, 14831, US

(21) Appl. No.: 11/974,268

(22) Filed: Oct. 12, 2007

Related U.S. Application Data
(63) Continuation of application No. 10/859,366, filed on Jun. 2, 2004, now abandoned.

(51) Int. Cl. C03B 19/00

(52) U.S. Cl. 65/53

(57) ABSTRACT

Methods and apparatus for manufacturing glass sheets are provided. The apparatus includes an inlet for delivering glass to a trough formed in a refractory body. The lowest point in the trough is located on the end opposite inlet end.

### CROSS-REFERENCE TO RELATED APPLICATION

The present application is a continuation application of U.S. patent application Ser. No. 10/859,366, filed on Jun. 2, 2004 and entitled “Defect Reduction in Manufacture Glass Sheets by Fusion Process.”

### FIELD OF THE INVENTION

This invention relates to the production of glass sheets by the fusion process.

### BACKGROUND OF THE INVENTION

Liquid crystal displays (LCDs) are flat panel display devices that include flat glass substrates or sheets. The fusion process is a preferred technique used to produce sheets of glass used in LCDs because the fusion process produces sheets whose surfaces have superior flatness and smoothness compared to sheet produced by other methods. The fusion process is described in U.S. Pat. Nos. 3,338,696 and 3,682,609, the contents of which are incorporated herein by reference.

FIG. 1 shows a schematic drawing of a prior art fusion apparatus 10, which is also known in the art as a downdraw apparatus. The apparatus 10 includes a supply inlet 12 which delivers molten glass to a trough 14 formed in a refractory body 16, which is also known in the art as an “isopipe.” The refractory body includes an inlet end 13 and a compression end 15 opposite the inlet end. After sufficient glass has entered the trough 14 so that steady state operation has been achieved, molten glass overflows over the top of the trough walls 18 on both sides, forming two sheets of glass that flow downward and inward along the outer surface of the refractory body 16. The two sheets meet at the bottom or what is typically called the root 19 of the refractory body 16, where they fuse together into a single sheet 20. The single sheet 20 is then fed to drawing equipment (represented schematically by arrows 22), which controls the thickness of the sheet by the rate at which the sheet is drawn away from the root 19. The drawing equipment is located downstream from the bottom so that the single sheet has cooled and become rigid before contacting the drawing equipment.

In prior art systems, the slope of the trough 14 is such that the trough has its maximum depth near the inlet end of the apparatus 10. One disadvantage of prior art systems is that when the trough is drained of glass after a production run, a large volume of glass accumulates in the deep end of the trough adjacent the inlet 12. The trough 14 is usually drained by tilting the refractory body 16, however, the design shown in FIG. 1 does not allow all of the residual glass to be drained from the trough. Higher density components of the glass composition tend to accumulate in the deep end of the trough, and these high density components can cause defects such as streak or inclusions in sheets drawn from the apparatus. In addition, when the process is idle, the glass in the deeper end of the trough near the inlet end changes composition through volatilization, changing the liquidus behavior of molten glass. During future furnace runs long flushing cycles are required to clear this area of sources of defects when the process is restarted. It would be desirable to provide a trough design that minimizes or reduces these problems.

### SUMMARY

The invention relates to an apparatus for forming glass sheets comprising a refractory body including an inlet end and a compression end and an inlet for delivering molten glass to the refractory body. The refractory body has a trough, wherein the lowest point in the trough is located on the end opposite inlet end. A pair of walls surrounds the trough on two sides and slope downwardly from the inlet end, the sidewalls extending between the inlet end and compression end of the refractory body. The sidewalls include top surfaces, and the trough and walls are arranged so that glass from the inlet fills the trough and flows over the top surfaces of the sidewalls between the inlet end and the compression end to form a glass sheet having substantially uniform thickness. In preferred embodiments, the trough is configured such that the trough can be drained substantially free of glass during process stoppages or changes in glass composition.

Advantages of the invention will be apparent from the following detailed description. It is to be understood that both the foregoing general description and the following detailed description are exemplary and are intended to provide further explanation of the invention as claimed.

### BRIEF DESCRIPTION OF THE DRAWINGS

FIG. 1 is a schematic drawing illustrating a representative construction of a prior art trough and refractory body used for making flat glass sheets;

FIG. 2 is a schematic drawing illustrating a representative construction of a trough and refractory body used for making flat glass sheets according to one embodiment of the present invention;

FIG. 3 is a cross-sectional view taken along line 3-3 of FIG. 2;

FIG. 4 is an enlarged cross-sectional view of the apparatus shown in FIG. 1.

FIG. 5 is a schematic illustration of the various angles of a trough according to the present invention.

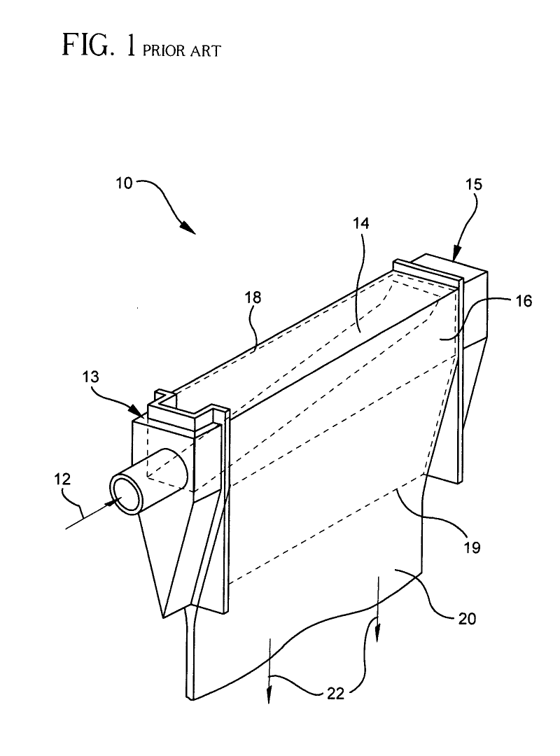

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

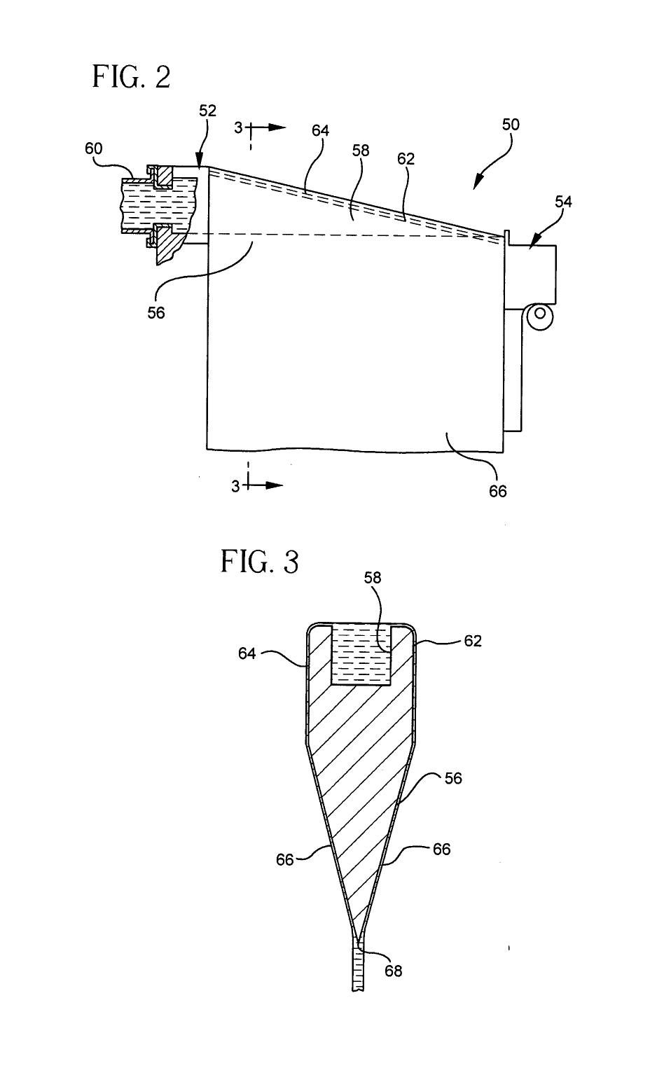

The invention pertains to apparatus used in fusion or overflow downdraw glass sheet manufacturing. FIG. 2 is a schematic representation of a fusion downdraw apparatus 50 according to one embodiment of the present invention. The apparatus includes an inlet end 52 and a compression end 54. The apparatus includes a refractory body or isopipe 56 that includes a trough 58 formed therein. An inlet 60 is in fluid communication with the refractory body such that it can deliver molten glass to the trough 58. FIG. 3 is a cross-sectional view taken along line 3-3 of FIG. 2. According to the present invention, the lowest point in the trough 58 is located on the end opposite inlet end. The trough is enclosed by two walls 62, 64 that slope downwardly from the inlet end 52 of the apparatus.

In operation of an apparatus during the fusion or overflow downdraw forming process, molten glass 66 flows into a trough, then overflows and runs down both sides of a refractory body or isopipe 56, fusing together at what is known as the bottom or root 68 (where the pipe ends and the two overflow portions of glass rejoin), and is drawn downward until cool. Further details of the overflow downdraw sheet manufacturing process are described, for example, in U.S. Pat. No. 3,338,696 (Dockerty) and U.S. Pat. No. 3,682,609 (Dockerty), the contents of which are incorporated herein by reference. One advantage to the fusion forming process is that the glass sheet can be formed without the glass surface contacting any refractory forming surfaces. This provides for a smooth, contaminant-free surface.

U.S. Pat. No. 3,338,696 describes a fusion downdraw sheet forming apparatus in which the slope of the trough from the inlet toward the compression end of apparatus is upward. U.S. Pat. No. 3,338,696 also proposed a mathematical relationship between the depth of the trough, the volumetric flow through the trough and the physical properties of the fluid and walls or weirs surrounding the trough and extending from the inlet end to the compression end of the apparatus.

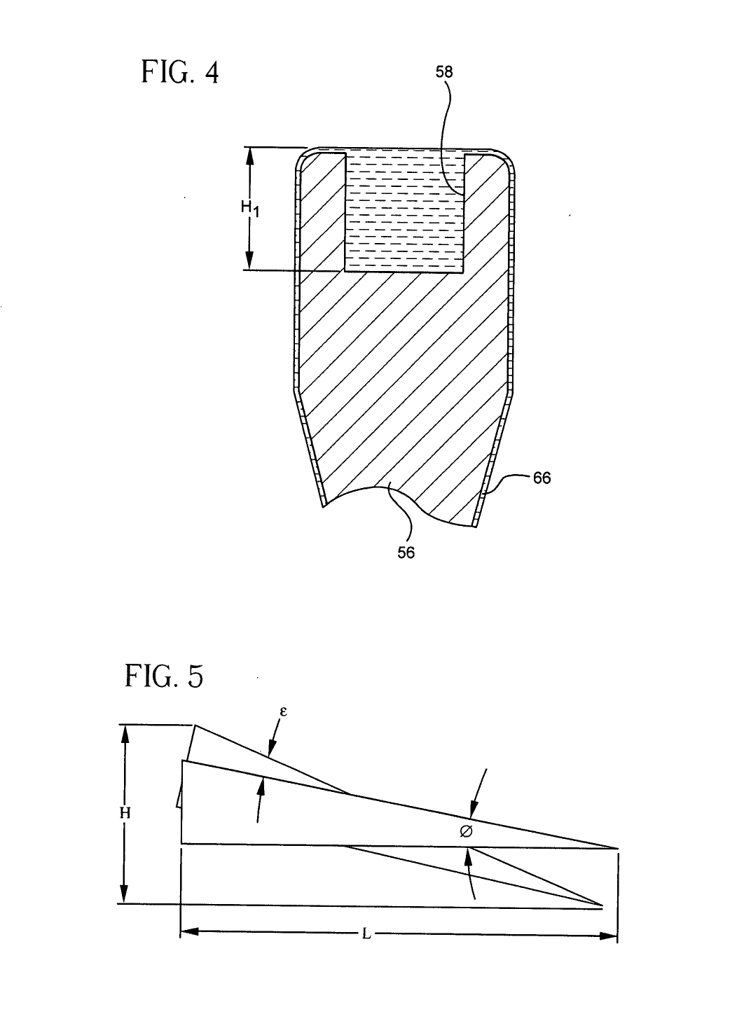

A variable a relates the ratio of the effective depth and width of the trough. U.S. Pat. No. 3,338,696 does not provide a preferred regime for the value of α. Referring to FIG. 4, and according to one aspect of the present invention, a relationship between trough depth (H) and width (W) is provided that reduces glass defects. According to one embodiment of the present invention, a relationship is proposed in which the trough is designed so that the maximum depth of the trough is at the compression end of the refractory body, which allows substantially all of the glass in the body to drain cleanly during shut down of the apparatus. As used herein, draining substantially all of the glass from the trough means that the depth of glass remaining in the trough after draining is less than about one-half inch of glass, preferably no more than about one-quarter inch, and most preferably no more than about one-eighth of an inch. In prior art systems, significant amounts of glass would remain in the trough after draining, and in particular, an amount of high density species of the glass composition, which would contaminate future batches of glass made in the apparatus leading to glass defects such as streaks and inclusions.

According to the present invention, with reference to FIG. 5, the depth of the trough 58 relative to the tops of the side walls 62 ad 64 at the inlet end 60 of the forming apparatus 50 is given by:

H=Tan(Ø+ε)*L, where

Ø=Angle of the side walls 62 and 64 of the forming apparatus 50 relative to a horizontal plane,

ε=maximum adjustment or tilt of the forming apparatus 50 relative to a horizontal plane, and

L=Length of the portion of the side walls 62 and 64 over which the glass flows.

The width of the trough 58 is dependent on physical properties of the glass, the operation conditions of the forming apparatus 50 and can be found empirically or mathematically using computational fluid dynamics or other computational methods.

The trough design of the present invention results in a decreased trough depth compared to trough depths in prior art systems. One major challenge in maintaining steady state operation during a fusion downdraw process is controlling the shape of the trough. The shape of the trough changes during the process due to material creep that causes structural sag in the refractory body that forms the trough. The walls of the trough can spread apart due to hydrostatic head from molten glass in the trough. A small amount of spreading in a portion of the trough walls can result in defects and rejected glass during the fusion downdraw manufacturing process. The spread of the trough walls can cause glass to preferentially flow to a central portion of the trough between the inlet end and compression end, which causes difficulty in maintaining stability of the sheet and thickness control of the glass sheet. Spreading of the walls is related to the wall height and wall thickness. The shorter walls provided by the present invention reduce the effect of hydrostatic head and greatly improves dimensional stability and process stability, extending the life of the fusion apparatus. Although dimensional stability could be improved by increasing the wall thickness, thus allowing higher walls to be used, this approach is generally undesirable because it requires a larger block of refractory material which is difficult to manufacture.

The apparatus described above can be used to manufacture sheets viscoelastic materials, including but not limited to polymers and silicate glass compositions. Preferred glasses are aluminosilicate or boro-aluminosilicate glasses. The invention is particularly useful for forming high melting or high strain point glasses, e.g. those used for manufacturing glass substrates for flat panel display devices. The invention is particularly useful for making boro-aluminosilicate and aluminosilicate glasses, particularly those which have melting points (defined herein as the temperature in which the viscosity corresponds to 200 poise) greater than about 1500° C., as well as glasses having high strain points, i.e., greater than 630°, more preferably greater than 640° C. The invention is especially useful in forming glass sheets having a silica content greater than 60%. Such glasses are sold by Corning, Inc under the trademark EAGLE 2000. However, the present invention is not limited to the manufacture of any particular type of glass. Such glasses are employed in a number of technologies, and in particular, the formation of high strain point glass sheet substrates for flat panel displays. The methods of the present invention enable the formation of other high strain point (i.e., greater than about 630° C.) silicate glasses, particularly aluminosilicate and boro-aluminosilicate glasses.

In other embodiments, an apparatus can be used to form sheets from other viscoelastic materials such as polymers. According to these embodiment, the apparatus includes a main body including an inlet end and a compression end, and the main body does not have to be a refractory. The other components of the apparatus are similar to the glass forming apparatus described above and include an inlet for delivering viscoelastic material to the main body, and a trough formed in the main body where the lowest point in the trough is located on the end opposite the inlet end. The apparatus further includes a pair of sidewalls sloping downwardly from the inlet end, the sidewalls extending between the inlet end and compression end of the main body and surrounding the trough on two sides and including top surfaces. According to this embodiment, the trough and walls are arranged so that viscoelastic material from the inlet fills the trough and flows over the top surfaces of the sidewalls between the inlet end and the compression end to form a sheet having substantially uniform thickness.

It will be apparent to those skilled in the art that various modifications and variations can be made to the present invention without departing from the spirit or scope of the invention. Thus, it is intended that the present invention cover modifications and variations of this invention provided they come within the scope of the appended claims and their equivalents.

What is claimed is:

1. A process for forming glass sheets comprising:
(I) providing a refractory body including:
an inlet end and a compression end;
an inlet for delivering molten glass to the refractory body;
a trough formed in the refractory body, wherein the lowest point in the trough is located on the compression end opposite the inlet end and there is a downward slope of the trough from the inlet end to the compression end; and
a pair of sidewalls sloping downwardly from the inlet end, the sidewalls extending between the inlet end and compression end of the refractory body and surrounding the trough on two sides and including top surfaces;
(II) delivering molten glass into the refractory body through the inlet;
(III) filling the trough with the glass and letting the glass to flow over the top surfaces of the sidewalls between the inlet ends and the compression end;
(IV) forming a glass sheet having substantially uniform thickness from the flowing glass; and
(V) draining substantially all the glass out of the trough at the end of a manufacturing cycle.

2. A process according to claim 1, wherein in step (V), after the trough is drained the film of glass remaining in the bottom of the trough has a depth of less than about one-half inch.

3. A process according to claim 1, wherein in step (V), after the trough is drained the film of glass remaining in the bottom of the trough has a depth of less than about one-quarter inch.

4. A process according to claim 1, wherein in step (V), after the trough is drained the film of glass remaining in the bottom of the trough has a depth of less than about one-eighth inch.

5. A process according to claim 1, wherein the glass is a boro-aluminosilicate glass.

6. A process according to claim 1, wherein the glass sheet has a high strain point and used in flat panel displays.

7. A process according to claim 1, wherein depth of the trough is equal to or less than H where H is provided by the following relationship,
H=Tan(Ø+ε)*L, where
Ø=Angle of the wall of the forming apparatus,
ε=maximum adjustment or tilt of the forming apparatus, and
L=Length of the portion of walls which glass flows over.

8. A process according to claim 1, further comprising the following step (VI) after step (V):
(VI) beginning a new manufacturing cycle by delivering molten glass into the trough.

9. A process according to claim 8, wherein in step (VI), contamination of the molten glass delivered into the trough by residual glass carried over from a previous manufacture cycle is reduced compared to a process using a refractory body having a trough without a downward slope of the trough from the inlet end to the compression end.
